(19) United States
(12) Patent Application Publication
(10) Pub. No.: US 2017/0170662 A1
(43) Pub. Date: Jun. 15, 2017

(54) Parallel-Connected Solar Panel Array System with Split Inverter

(71) Applicants: Marvin S. Keshner, Sonora, CA (US); Erik Vaaler, Redwood City, CA (US)

(72) Inventors: Marvin S. Keshner, Sonora, CA (US); Erik Vaaler, Redwood City, CA (US)

(21) Appl. No.: 14/969,547

(22) Filed: Dec. 15, 2015

(51) Int. Cl. H02J 3/38; H02M 7/44; H02M 3/04

(52) U.S. Cl. CPC H02J 3/383; H02M 3/04; H02M 7/44

(57) ABSTRACT

A solar panel array system comprising one or more groups of panels, the panels within each group being connected in parallel with each other, and a two-stage split solar inverter. The split inverter comprises a first stage and a second stage. The first stage comprises one or more DC-to-DC converters, each having a first input port and a first output port. Each solar panel within a group of solar panels is connected in parallel to the first input port. The second stage comprises a DC-to-AC inverter having a second input port and a second output port. The first outputs of each DC-to-DC converter are connected in parallel to the second input port of the DC-to-AC inverter. When each DC-to-DC converter is positioned in close proximity to the corresponding group and when the second stage is positioned remotely from it, the second output port provides power to an AC power line.

This application is related to U.S. patent application Ser. No. 14/247,746, entitled A PARALLEL-CONNECTED SOLAR ELECTRIC SYSTEM, filed on Apr. 8, 2014, which is hereby incorporated by reference, as if it is set forth in full in this specification.

### FIELD OF INVENTION

This invention relates to photovoltaic solar panel installations for converting sunlight to DC electricity and then converting the DC electricity into AC electricity with a DC to AC inverter.

### BACKGROUND

Photovoltaic solar panels are commonly installed on rooftops or on the ground to collect sunlight and convert the sunlight into DC electricity. Most often, a large group of solar panels are connected to a single DC to AC inverter that converts the DC power from the solar panels into AC power (typically 50 or 60 Hz) and connects to the AC power line.

In common practice, the solar panels are electrically connected in series with each other into long strings that can vary from 5-30 solar panels per string. The series-connected strings are then connected in parallel to each other and in parallel to the inputs of the DC to AC converter.

The minimum length of the strings, where length in this context means the number of panels in each string, is limited by the ability of the DC to AC inverter to handle large currents and to efficiently convert power at high current and low voltage from DC to AC. For example, an array of 12 solar panels can be connected into a single string of length 12. If the solar panels are conventional 60-cell, poly-silicon, solar panels, then the string and thus the array will have an operating voltage of about 324 volts DC and an operating current of about 8 amps. Connecting the array as 4 strings of 3 panels each will produce an operating voltage of about 81 volts DC and an operating current of about 32 amps. Connecting all of the panels in parallel will produce an operating voltage for the array of about 27 volts DC and an operating current of 96 amps. Typical prior art inverters are not designed for such low operating voltages and high operating currents.

The maximum length of the strings is limited by the maximum voltage rating of the solar panels to either 600V or 1000V, and the maximum voltage range rating of the inverter (e.g. 0 to 600V, 0 to 1000V, or −600V to +600V). The single solar inverter is then required efficiently to convert DC to AC power with the operating input voltage varying over a wide range. The operating input voltages vary with length of the series-connected strings, with the intensity of the sunlight, and also with the operating temperature of the solar panels.

Recently, micro-inverters have been developed. With these devices, each solar panel or pair of solar panels has its own DC to AC inverter. The micro-inverters are connected in parallel with each other onto the AC power line.

For rooftop installations, partial shading of the array of solar panels is an important issue. Partial shading can arise from trees, power poles, chimneys, ventilation shafts and other items mounted on the rooftop. When solar panels are series-connected into long strings, and when one solar panel or a cell within one solar panel is shaded, then the power output of the entire series-connected string is reduced.

For example, consider an array of 10 solar panels, each of which is designed to produce 250 watts of electrical power in full sunlight. If one solar panel is partially shaded and only able to produce 10% of its rated power, and the other 9 solar panels are not shaded and in full sunlight, then the total power available from the array would be: 9×250 watt+0.1×250 watts=2275 watts out of a maximum of 2500 watts. However, if the 10 solar panels are connected in series, and ignoring the effect of by-pass diodes that are sometimes included within the solar panels, the current of the string of 10 panels will be limited by the current of the shaded panel to about 10% of its maximum current. All of the panels in the string of 10 will operate at only 10% of their rated current and about 10% of their rated power. The result is that only 250 watts of power are produced.

Of course, solar installers design the installation to minimize shading of the solar panels. Nevertheless, some shading is common—especially on residential rooftops, where space is limited, and sources of shading are abundant and not easily modified. It is estimated by companies like Enphase Energy that partial shading of solar panels that are series-connected into strings reduces the total energy production of a residential rooftop solar installation by as much as 20%.

Series strings of solar panels have an additional issue. The power produced by each panel in full sunlight varies. Most manufacturers of solar panels bin their products to reduce the variation. However, the amount of power produced often varies by up to +3% relative to the nominal power for that bin. The average value of the power produced by a group of 10 solar panels might therefore be anticipated to be approximately +1.5% above the nominal power for that bin. However, when 10 solar panels are connected in series, their performance will be limited by the current and power of the weakest solar panel. Hence, the power of a string of 10 will be very close to the 10*(nominal power/per panel), rather than the “anticipated” average, which would be 10*1.015*(nominal power/per panel).

Micro-inverters (and also solar power conditioners) have been developed to reduce the impact of partial shading of the solar panels on a rooftop. Each solar panel has its own DC to AC micro-power-inverter, and the micro-inverters are all connected in parallel. If one of the solar panels is shaded and has reduced output, its inverter will deliver less power to the AC power line, but the other solar panels and their micro-inverters are unaffected. They will continue to produce power that will depend only on the amount of sunlight collected by each and independent of the circumstances of other solar panels. With micro-inverters, one can avoid most of the reduction of total energy due to the combination of partial shading and series-connected strings of solar panels.

Unfortunately, using one micro-inverter per one or two solar panels has several serious disadvantages compared with using a single inverter for the entire rooftop solar installation. First, there are several cost disadvantages. Micro-inverters on the market today are typically 50% more expensive per watt than single inverters for the entire installation. Other aspects of a solar installation with micro-inverters are also more expensive because micro-inverters require extra mounting hardware and additional connectors. Micro-inverters also require that AC wiring be run on the roof and connected to each of the micro-inverters. Single inverters require only a small number of short DC wires.

Second, there are several reliability issues. The micro-inverters are often located underneath the solar panels. The sunlight heats the solar panels and the daytime maximum temperatures underneath the solar panels may be very high. As a result, the micro-inverters experience very large temperature cycles every day. Frequent, large temperature cycles are well-known as a key cause of failures for electronic devices. In contrast, single inverters are usually not mounted on the roof. They are mounted under the eaves of the roof, where they are not heated by direct sunlight (especially during the hot part of the day) and where they do not experience large temperature cycles each day. Also, the temperature under the eaves of the roof tends to be moderated by the thermal mass and steady internal temperature of the building. It is considerably less cold at night and less hot during the day than the rooftop. Exposure to smaller temperature cycles each day makes ensuring the reliability of single inverters much easier.

Power inverters that include two portions, the first with DC-to-DC power conversion and the second with DC-to-AC inversion, may address some of these problems by keeping the first portion close to the solar panels for efficiency, but allowing the second portion to be positioned relatively remotely, in a location that is less exposed to extremes of temperature, and allows convenient access. Some “split” devices of this type are known, the power conditioners from Solar Edge for example, but they are specifically designed to be operated with solar panels connected in a series configuration. A Solar Edge power conditioner is connected to one solar panel. Then, the power conditioners are connected in series. Then, the series string of power conditioners is connected to the input of a DC to AC inverter.

Therefore, there is a need for a new type of solar panel array system that combines the cost and energy production advantages of a parallel connected solar panel array with the convenience and reliability advantages of a split inverter that is specifically designed to operate with such an array.

### SUMMARY

The present invention includes a solar panel array system comprising one or more groups of solar panels, the panels within each group being connected in parallel with each other, and a split power inverter. The split power inverter comprises a first stage and a second stage. The first stage comprises one or more DC-to-DC power converters; each power converter having a first input port and a first output port, and each of the solar panels within a corresponding group of solar panels being connected in parallel to the first input port. The second stage comprises a DC-to-AC inverter having a second input port and a second output port, the first outputs of each DC-to-DC converter of the first stage being connected in parallel to the second input port of the DC-to-AC inverter of the second stage. When each DC-to-DC power converter is positioned in close proximity to the corresponding group of solar panels and when the second stage is positioned remotely from the corresponding group of solar panels, the second output port provides power originating from the solar panel array to an AC power line.

In another aspect, the solar panels are first divided into sub-groups of two or more solar panels that are electrically connected in series, and then some of these sub-groups of series-connected solar panels forming a group are electrically connected in parallel and in parallel with the DC input of an DC-to-DC voltage boost power converter in the first stage of a split power inverter.

### BRIEF DESCRIPTION OF DRAWINGS

FIG. 1—An example of a solar panel array installation including a split inverter according to one embodiment.

FIG. 2—A residential rooftop solar installation including a split inverter according to one embodiment.

FIG. 3—A commercial rooftop solar installation including a split inverter according to another embodiment.

FIG. 4—A functional diagram for a solar installation including a split inverter according to one embodiment.

FIG. 5—A rooftop solar installation including a split inverter with shielded power converters according to one embodiment.

FIG. 6—A functional diagram for a solar installation including a split inverter according to one embodiment.

### DETAILED DESCRIPTION

Embodiments of the present invention are solar panel array systems, each made up of one or more groups of panels that are connected in parallel, rather than in series, and a two-stage split solar inverter, designed for use with such groups of panels. In each case, the first stage of the split inverter includes one or more DC-to-DC converters, and the second stage includes a DC-to-AC solar inverter, whose output is connected to an AC power line that may be tied either to the electrical grid or to a more limited, localized power delivery system, for example one supplying power to a single building.

Each panel of a group of solar panels is connected in parallel to the input of one first stage, DC-to-DC converter, which is located in close proximity to that group of solar panels. The output of that first stage converter and the outputs of any other first stage converters present in the two-stage inverter are connected in parallel to the input of the second stage DC-to-AC inverter, which may be located remotely from the group or groups of panels.

Throughout this specification the terms “close” and “close proximity” are used with their standard meanings to indicate positioning adjacent to, near, in the vicinity of etc. In a typical case where the solar panels are distributed over a rooftop, each DC to DC converter will be in the same rooftop area as the corresponding group of panels to which it is connected. Similarly, the terms “remote” and “positioned remotely” are used with their standard meanings to indicate positioning at a significant distance from the panels in question, the distance being sufficiently great to provide materially different environmental conditions, including temperature.

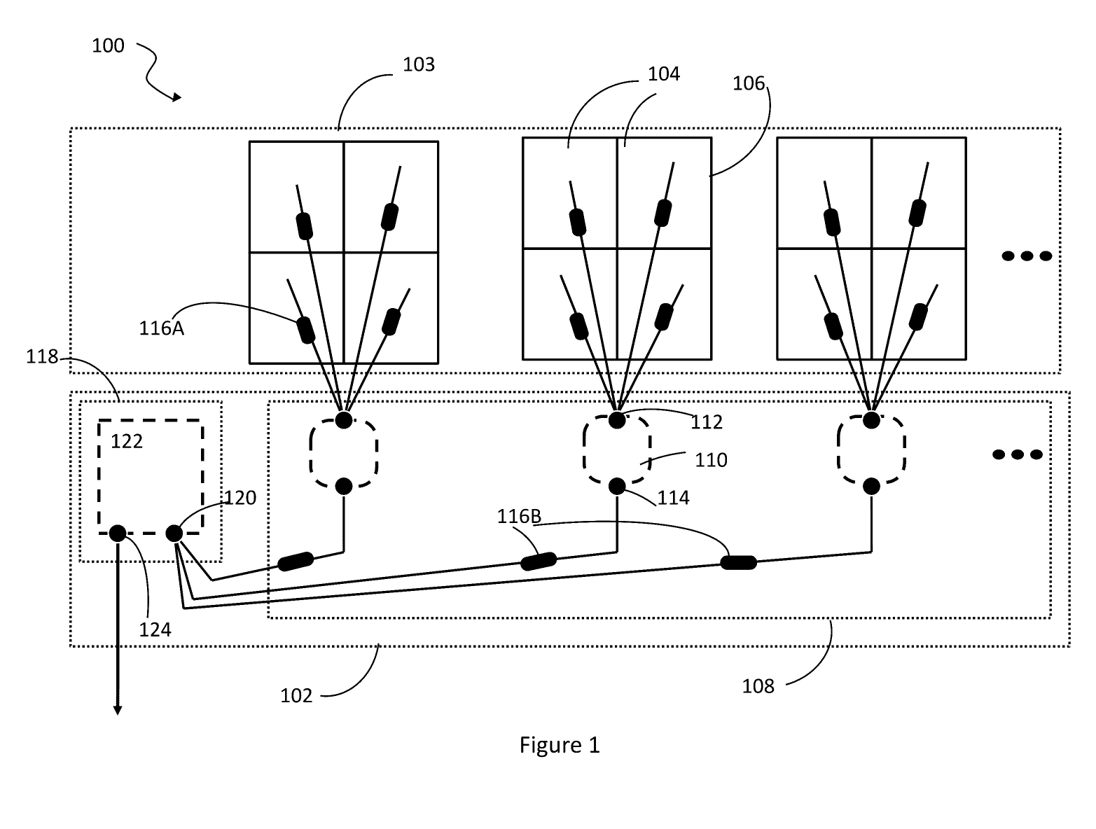

FIG. 1 illustrates one example of a solar panel array installation 100 including a split inverter 102 made up of first stage 108 and second stage 118 according to one embodiment of the present invention. In the case shown, the array 103 of solar panels 104 is divided into groups 106 of 4 panels each. Each panel is connected in series with a fuse 116A. Then, for each group, all four panels 104 are connected in parallel with each other and in parallel with the input port 112 of one of the DC-to-DC voltage boost converters 110 of first stage 108. Each converter 110 is located in close proximity to its corresponding group 106 The output of each first stage converter 110, corresponding to a specific group of solar panels in the array, is connected in series with a fuse 116B and then in parallel with the outputs of the other converters 110 in first stage 108 to the input port 120 of the DC-to-AC solar inverter 122 in second stage 118. The output fuses 116B may be physically located within the DC to DC converters 110 or within the DC to AC inverter 122. Second stage 118 may be located remotely from first stage 108. The output port 124 of the DC-to-AC solar inverter 122 is connected directly to an AC power line, which may be grid-tied or stand-alone.

In reality, there will be pairs of wires (positive and negative polarity) running from each solar panel 104 to the corresponding DC-to-DC voltage-boost power converter 110 and from the DC-to-DC voltage-boost power converters 110 to the DC-to-AC solar inverter 122, but they are shown as single rather than dual lines in FIGS. 1, 2, 3 and 5 for simplicity.

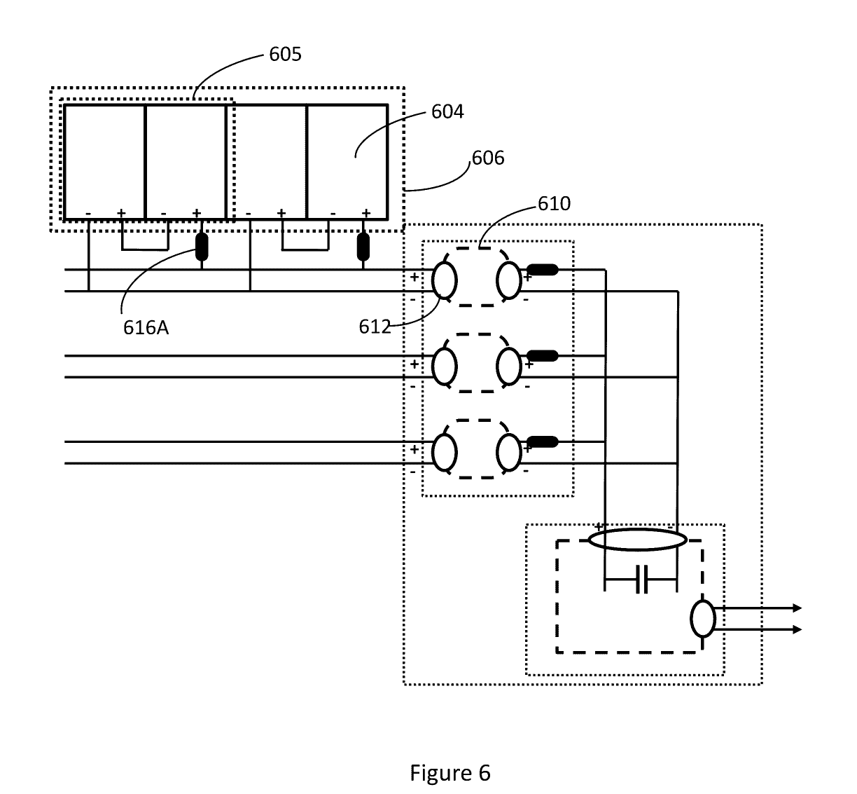

In another embodiment, shown in FIG. 6, rather than each panel 104 being connected to a single corresponding fuse 116A, as in the embodiment shown in FIG. 1, each group 606 of solar panels 604 is divided into small sub-groups 605 of panels, with 2 or more panels per sub-group. Each panel in a sub-group 605 is connected in series and in series with a fuse 616A. Then, the sub-groups of solar panels are connected in parallel with each other and in parallel with the input port 612 of each of the DC-to-DC converters 610.

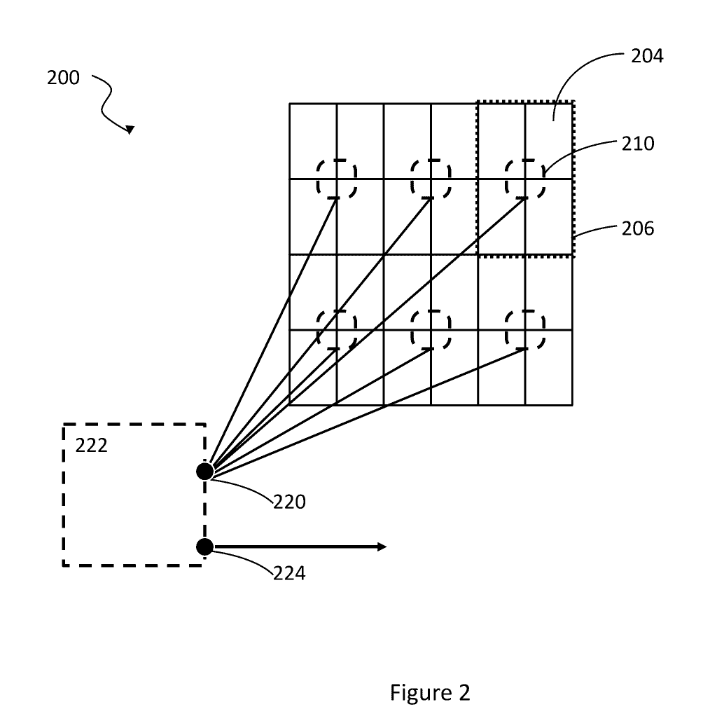

FIG. 2 illustrates an example of a solar panel array installation 200 on a residential rooftop, where significant shading may occur. In the case shown, each group 206 of solar panels is made up of 4 panels 204, in close proximity to each other. Each solar panel is connected in series with a fuse (not shown in the figure for simplicity) to prevent large currents from flowing into the solar panel in the event that the panel shorts. The 4 solar panels (each with their fuses) are connected in parallel and in parallel with the input port (also omitted from the figure for simplicity) of the DC-to-DC converter 210. Each converter 210 is located in close proximity to its corresponding group 206. The DC-to-DC converter boosts the DC voltage substantially, for example, by 15-25×, depending on the design. For example, with a boost of 20×, the voltage would be boosted from the 20-30 volts produced by the solar panels to 400-600 volts at the output of the converter. The current would be reduced by 20×, from approximately 32 amps produced by 4 solar panels in parallel to 1.6 amps at the output of the converter. The output ports of the DC to DC converters 210 are connected in parallel to the input port 220 of DC-to-AC inverter 222, which in turn provides output AC power at port 224. Fuses present in the wires connecting converters 210 to inverter 222 are omitted from the figure for simplicity.

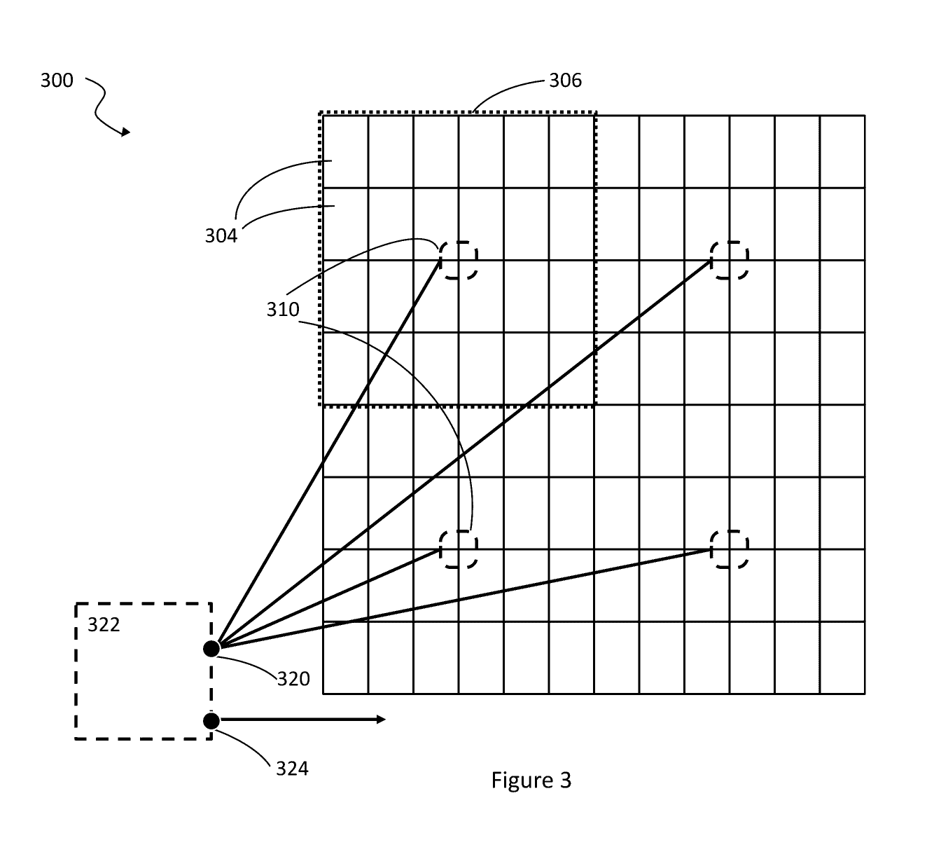

FIG. 3 illustrates another example of a solar panel installation 300 suitable for a commercial rooftop that is much larger than a typical residential rooftop, The number of panels in each group 306 of solar panels may be chosen to be correspondingly larger for such a commercial installation. In the example shown, there are 24 solar panels 304 in relatively close proximity to each other making up each group 306, each panel in the group being connected in parallel with the other panels in the group and with the input port of a corresponding, shared DC-to-DC converter 310. Each converter 310 is located in close proximity to its corresponding group 306. The output of each first stage converter 310, corresponding to a specific group of solar panels in the array, is connected in parallel with the outputs of the other converters 310 to the input port 320 of the DC-to-AC solar inverter 322. Solar inverter 322 may be located remotely from the power converters 310. The output port 324 of the DC-to-AC solar inverter 122 is connected directly to the AC power line, which may be grid-tied or stand-alone.

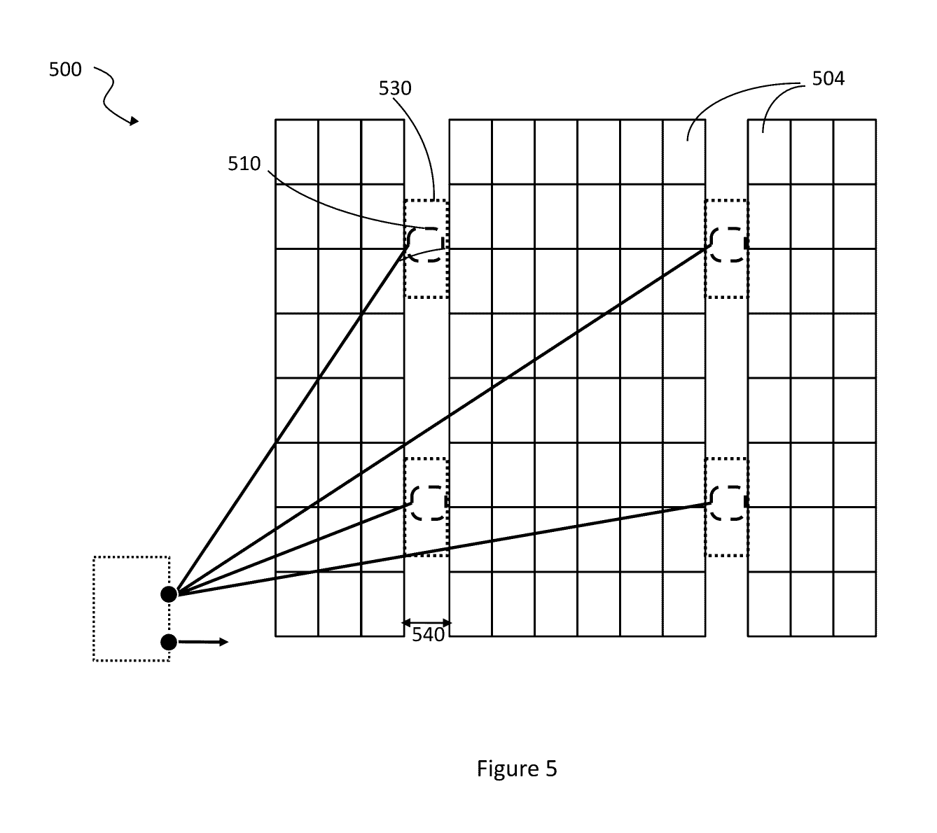

Fuses are omitted from FIGS. 3 and 5 for simplicity.

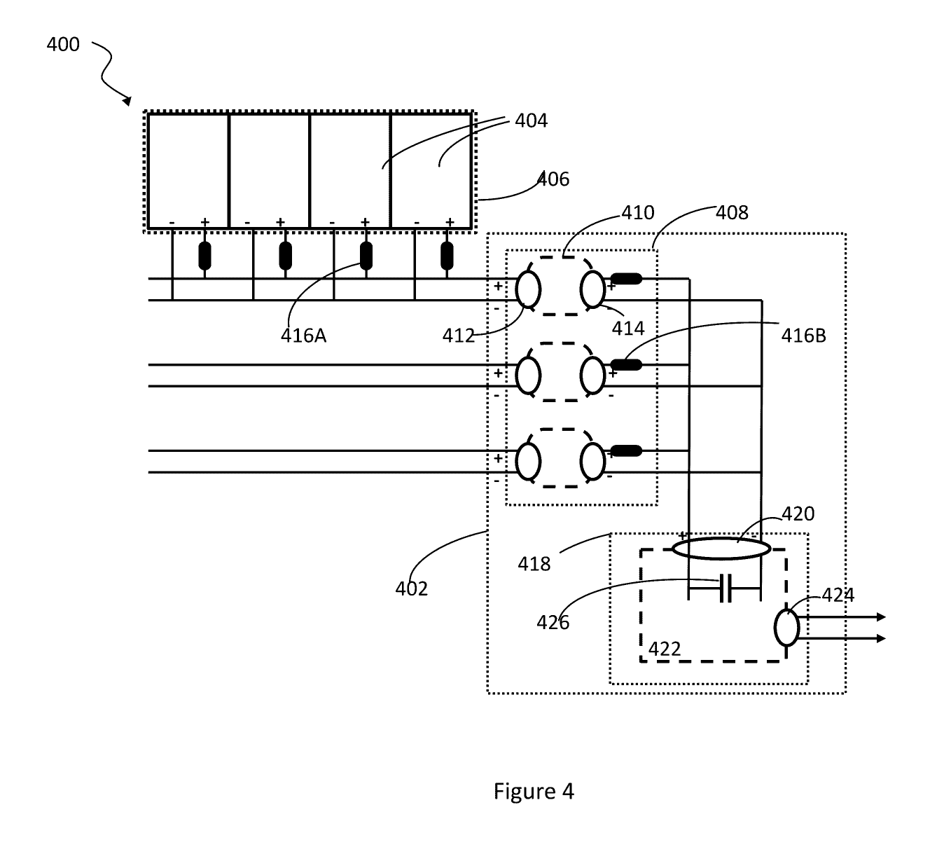

FIG. 4 illustrates a function diagram for an exemplary solar installation 400 including two-stage split inverter 402. It shows groups 406 of solar panels (one is shown explicitly, two others are implied) with each group's panels connected in parallel with each other and with the input port 412 of a DC-to-DC converter 410 of first stage 408 of inverter 402. Each converter 410 boosts the voltage delivered to it by the corresponding group of panels. Fuses 416A are shown in series with each solar panel and fuses 416B are shown in series with the output of each of the first stage converters. The fuses 416A may be physically within the DC to DC converters 410 and the output fuses 416B may be physically within either the DC to DC converters 410 or the DC to AC inverter 422. The outputs from output ports 414 of the first stage DC to DC converters 410 are wired in parallel with each other and in parallel with the input port 420 of DC-to-AC solar inverter 422 in the second stage 418 of split inverter 402. Capacitive element 426 provides energy storage at the input 420 of the DC-to-AC solar inverter 422. The output port 424 of the second stage inverter 422 is connected to the AC power line.

Connecting wires are shown as dual, positive and negative polarity lines FIGS. 4 and 6, with corresponding positive and negative polarity connection points at corresponding input and output ports.

The positioning of first stage DC-to-DC converters on the roof close to the corresponding groups of solar panels delivering power to them has several advantages. The first advantage is lower cost and power loss for the connecting wires. Short wires can be used to connect each panel to the converter. In the residential roof example with only 4 panels per converter, the wires already attached to the solar panels themselves are often long enough to connect directly to the converter. Much longer wires are required from each converter to the input of the DC-to-AC inverter. However, with the boosted voltage and reduced current, these wires can be #10, #12 or maybe #14 gauge, depending on their length. With 4 panels producing 1 kW of power, a voltage boost of 20×, and a total wire length of 30 feet, a pair of #14 wires from the output of the converter to the input of the inverter would dissipate only 0.2 W—less than .02% of the power. In contrast, if the 4 solar panels were wired directly to the DC-to-AC inverter, without passage through the first stage converters, the power loss would be 75 W or 7.5% of the power.

The wire lengths on a commercial rooftop are much longer. Therefore, the advantage of lower cost and power loss for the connecting wires is much greater on a commercial rooftop. For the example with a group of 24 panels connected to each converter, the total power for the group is 6 kW. With a voltage boost of 20× and a total wire length of 200′ (on average), the power dissipated in a #10 gauge wire would be 20 W or 0.3% of the power. In contrast, without the use of DC-to-DC converter close to the group of solar panels, and with the panels connected in parallel, the current would be almost 200 A. Even with a #0 gauge wire, the power lost would be 800 W or 13%.

The second advantage provided by the present invention for both residential and commercial rooftop installations is that in using parallel-connected panel arrays, less power loss occurs due to shading of some of the solar panels, or to intrinsic panel-to-panel variability. In a conventional installation, 8-14 solar panels are connected in series. If one solar panel is shaded, the power output of the entire group is greatly reduced. With this invention, the solar panels are connected in parallel. Shading one panel has almost no effect on any of the other panels.

The third advantage for commercial rooftop installations is that the first stage accepts the input of many solar panels. Anywhere from 24-48 panels per converter would be common. It takes the place of many of the combiner boxes that normally are used to aggregate the output of solar panels on a commercial rooftop.

In summary, this invention allows the known advantage of parallel-connected solar panels, especially in greatly reducing the impact of shading, to be retained, while significantly reducing the expected disadvantages of large wire cost and power loss that usually result from such a parallel connection of solar panels. This is achieved by the use of a spatially distributed split inverter, with one or more DC-to-DC voltage-boost power converters located close to the solar panels, while the DC-to-AC inverter may be located at a convenient and more reliable, relatively remote location.

The first stage, DC-to-DC converters can be mounted underneath the solar panels, where they are somewhat protected from direct sun and rain. Such arrangements are shown in FIGS. 2 and 3. They can also be mounted in a gap between the solar panels and underneath sun-shades, which can be as simple as pieces of reflective metal. FIG. 5 illustrates an example of a rooftop solar installation 500 that includes such shielded power converters. Shields 530 are positioned over DC to DC converters 510, which are themselves positioned in gaps 540 between solar panels 504.

Compared with micro-inverters and power conditioners, this invention has several distinctions. A micro-inverter is connected directly to each panel (or pair of panels). It boosts the DC voltage and then inverts the DC to AC all in one package. A micro-inverter is not a spatially distributed, two-stage split inverter, as is the inverter disclosed in this invention.

Power conditioners of the type known and used prior to the present invention also connect directly to solar panels, but the DC outputs of the power conditioners are connected in series. In this invention, the outputs of the first stage, voltage-boost power converters are connected in parallel. The power conditioners of prior art boost the voltage of the solar panels by only a small amount. Only with a series connection of 8-12 power conditioners is a voltage of 400-600 volts achieved. In this invention, each first stage voltage-boost DC-to-DC power converter boosts the voltage to 400-600 volts. The first stage power converters are then all connected in parallel. For power conditioners, there may be several series connections of 8-12 power conditioners that are then connected in parallel at the input of the DC-to-AC solar inverter, which is then connected to the AC power line. Nevertheless, they are first connected in series, and then the series strings are connected in parallel.

The second stage, DC-to-AC solar inverter of the present invention is very similar to conventional solar inverters. Like many conventional solar inverters, it accepts at its input a DC voltage in the range of 400-600 volts. Like many conventional solar inverters, it produces AC at its output. In some embodiments, it may even be a conventional solar inverter. The AC power at its output can be 50 Hz or 60 Hz, with various voltages to match the local codes, with various phase angles, and may be either single phase or three phase. The AC output can be designed to be tied to the electrical grid or to be operated without a connection to the electrical grid. It has all of the safety features required of a solar inverter.

Unlike many convention solar inverters, the energy storage in the two-stage inverter of the present invention can be accomplished by adding capacitance at the input to the second stage DC-to-AC solar inverter. For a solar inverter with a single-phase output, the power output varies with time as:

Power output=(Average Power Output)*[1+cos(2π*120 Hz*t)]

Without energy storage anywhere in either stage of the inverter, the power flowing from the solar panels must be approximately the same as the power flowing out to the AC line. This will cause the voltage and current of the solar panels to vary in time. However, solar panels are best operated at a constant voltage and current that result in maximum power output. Time variation of power will cause the solar panels to operate away from their maximum power output voltage and current, resulting in a net loss of system efficiency.

For the two-stage inverter of this invention, it is effective to add one or more capacitors to store energy at the input to the second stage. This allows the capacitors to be placed along with the remainder of the second stage of the inverter at a location remotely situated with respect to the panels. A convenient location for the second stage of the inverter, with or without the added capacitors, is a shaded part of the roof, or off the rooftop altogether, maybe on a sidewall of the building, out of the sun. The first stage, however, is preferably located on the rooftop close to the solar panels to minimize the lengths of wire, and the wire cost and power loss.

On the top of a roof, the temperatures are much higher and the temperature cycles each day are much bigger. On the side of a building below the roof, the temperatures are lower and the temperature cycles are smaller. A location can be selected out of the sun. Also, the thermal mass of the building will moderate the temperature, making the second stage a little cooler in the summer and a little warmer in the winter. The more moderate temperatures and smaller temperature cycles of the second stage will improve the reliability of the capacitors used for energy storage.

In some embodiments, capacitance for energy storage may alternatively or additionally be introduced at the outputs of the DC-to-DC voltage-boost power converters. This will decrease the amount of 120 Hz ripple current that flows through the wires connecting the first stage converters to the second stage inverter.

Although the description has been described with respect to particular embodiments thereof, these particular embodiments are merely illustrative, and not restrictive. It will also be appreciated that one or more of the elements depicted in the drawings/figures can also be implemented in a more separated or integrated manner, or even removed or rendered as inoperable in certain cases, as is useful in accordance with a particular application. Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

1. A solar panel array system comprising
one or more groups of solar panels, the panels within each group being connected in parallel with each other; and
a split power inverter comprising:
a first stage comprising one or more DC-to-DC power converters; each power converter having a first input port and a first output port, and each of the solar panels within a corresponding group of solar panels being connected in parallel to the first input port; and
a second stage comprising a DC-to-AC inverter having a second input port and a second output port, the first outputs of each DC-to-DC converter of the first stage being connected in parallel to the second input port of the DC-to-AC inverter of the second stage;
wherein when each DC-to-DC power converter is positioned in close proximity to the corresponding group of solar panels and when the second stage is positioned remotely from the corresponding group of solar panels, the second output port provides power originating from the solar panel array to an AC power line.

2. The solar panel array system of claim 1;
wherein the DC-to-AC inverter of the second stage is a conventional solar inverter, such that in a conventional series connected solar panel array, the second input port would be connected to one or more strings of series connected solar panels.

3. The solar panel array system of claim 1;
wherein each DC-to-DC power converter is mounted between two solar panels and is shielded by a sun shade.

4. The solar panel array system of claim 1;
wherein each DC-to-DC power converter is characterized by a fixed voltage boost ratio of output voltage to input voltage.

5. The solar panel array system of claim 1;
wherein the second stage additionally comprises an energy storage capacitor at the second input port of the DC-to-AC inverter.

6. The solar panel array system of claim 2;
wherein the second stage additionally comprises an energy storage capacitor at the second input port of the DC-to-AC inverter.

7. A solar panel array system comprising:
a solar panel array comprising one or more groups of solar panels comprising a parallel connection of a first plurality of sub-groups of solar panels, each sub-group comprising a series connection of a second plurality of solar panels; and
a split power inverter comprising:
a first stage comprising one or more DC-to-DC power converters; each power converter having a first input port and a first output port, and each of the sub-groups of solar panels within a corresponding group of solar panels being connected in parallel to the first input port; and
a second stage comprising a DC-to-AC inverter having a second input port and a second output port, the first outputs of each DC-to-DC converter of the first stage being connected in parallel to the second input port of the DC-to-AC inverter of the second stage;
wherein when each DC-to-DC power converter is positioned in close proximity to the corresponding group of solar panels and when the second stage is positioned remotely from the corresponding group of solar panels, the second output port provides power originating from the solar panel array to an AC power line.

8. The solar panel array system of claim 7;
wherein each DC-to-DC power converter is mounted between two solar panels and is shielded by a sun shade.

9. The solar panel array system of claim 7;
wherein each DC-to-DC power converter is characterized by a fixed voltage boost ratio of output voltage to input voltage.

10. The solar panel array system of claim 7;
wherein the second stage additionally comprises an energy storage capacitor at the second input port of the DC-to-AC inverter.

11. The solar panel array system of claim 7;
wherein the second stage additionally comprises an energy storage capacitor at the second input port of the DC-to-AC inverter.
